(19) United States
(12) Patent Application Publication
(10) Pub. No.: US 2011/0130132 A1
(43) Pub. Date: Jun. 2, 2011

(54) SYSTEM AND METHOD FOR INHIBITING TEENAGERS' TEXTING WHILE DRIVING MOVING VEHICLES

(76) Inventor: Gerald John (Jack) Lipovski, Austin, TX (US)

(21) Appl. No.: 13/025,017

(22) Filed: Feb. 10, 2011

Related U.S. Application Data
(63) Continuation-in-part of application No. 12/943,121, filed on Nov. 10, 2010.
Application No. 12/943,121 is a continuation-in-part of application No. 12/785,449, filed on May 22, 2010, now Pat. No. 7,856,203.
Application No. 12/785,449 is a continuation-in-part of application No. 11/865,810, filed on Oct. 2, 2007.
Application No. 11/865,810 is a continuation-in-part of application No. 11/511,723, filed on Aug. 29, 2006, now Pat. No. 7,363,042.
Application No. 11/511,723 is a continuation of application No. 10/687,024, filed on Oct. 16, 2003, now Pat. No. 7,142,877.
Application No. 10/687,024 is a continuation of application No. 09/384,723, filed on Aug. 27, 1999, now Pat. No. 6,675,002.

(51) Int. Cl. H04M 3/00

(52) U.S. Cl. 455/418

(57) ABSTRACT

A system is disclosed for preventing teenage moving vehicle drivers from cellphone texting while that vehicle is moving. This system comprises a motion detector, ignition key input that indicates whether the driver is a teenager, and courtesy signal transmitter in a vehicle which sends the state of its motion detector and ignition key to a cellphone having a text keyboard, a microphone, and a courtesy signal receiver disposed in the microphone which is in the keyboard. Said vehicle may have a moving vehicle driver, who may also be the aforementioned cellphone user, disposed to operate these cellphone devices. The cellphone may enable or disable the driver's keyboard based on the motion indicator, closeness to the driver, or driver's maturity, but this determination may be overridden by the cellphone service provider, or person inserting an ignition key that permits texting while driving.

### RELATED U.S. APPLICATION DATA

This application is a continuation-in-part of application Ser. No. 12/943,121, filed Nov. 10, 2010, which is a continuation-in-part of application Ser. No. 12/785,449, filed May 22, 2010, now U.S. Pat. No. 7,856,203 (the '203), which is a continuation-in-part of application Ser. No. 11/865,810, filed Oct. 2, 2007, which is a continuation-in-part of application Ser. No. 11/511,723, filed Aug. 29, 2006, now U.S. Pat. No. 7,363,042, which is a continuation of application Ser. No. 10/687,024, filed Oct. 16, 2003 now U.S. Pat. No. 7,142,877, which is a continuation of application Ser. No. 09/384,723, filed Aug. 27, 1999 now U.S. Pat. No. 6,675,002. This application also claims benefit of U.S. Provisional Application No. 60/936,605, filed Jun. 21, 2007. These applications and patents are incorporated herein by reference.

### BACKGROUND OF THE INVENTION

This invention is in the field of automatically inhibiting a moving vehicle's teenage driver from texting and doing other similar excessively dangerous activities. A number of closely related systems have been put forth in the specifications of this application's parent patents and applications. They are comprised of at least one courteous cellphone, this cellphone being comprised further of a keyboard and one or more courtesy signal receivers. (A courteous cellphone is a conventional cellphone that is enhanced with mechanisms described in this application. Generally, subsystems of and modules of this system are said to be courteous-cellphone compliant.) A courtesy signal is generally information received from or transmitted to the aforementioned courteous-cellphone compliant components which are discussed herein. Such a signal is generally conveyed over a carrier such as low-power radiofrequency carrier or ultrasonic carrier, but a courtesy signal could be carried on copper trace, wire, coax or fiber-optical carrier. The present parent application discloses improved mechanisms for the courtesy signal transmitter of one of the data sources, the courtesy signal transmission path, and courtesy signal receiver. Although this application primarily shows modifications to the design disclosed in the '203 patent, the modifications also apply to the designs put forth in this application's other parent patents and applications wherever the modifications are appropriate.

Currently the US Department of Transportation appears to be considering a rule to inhibit any texting while driving a moving vehicle on US highways. This rule includes the consideration of whether or not the current driver is a teenager, to appeal to parents of teenagers who would like to prevent their teenager children from using cellphones while driving because teenagers have many accidents while texting and driving, but the parents themselves appear to be less inclined to automatically inhibit themselves from texting while they are driving, preferring rather to be on their own recognizance to drive safely.

The source of one of the '203's courtesy signal could be a motion indicator that is coupled to the moving vehicle's frame, such as were listed in the '203: a speedometer-based motion sensor, an accelerometer-based motion sensor, or a noise-based motion sensor—this being transmitted to all cellphones in the aforementioned vehicle over courtesy signals to eventually determine if the vehicle is in motion. This courtesy signal causes the cellphone to react differently to the cellphone commands and data when the vehicle is moving. This courtesy signal, whether encoded onto a single signal carrier or transmitted on different carriers from courtesy signal transmitters to courtesy signal receivers, needs also to convey whether the vehicle's driver, who is using the cellphone, is a teenager, so that the cellphone can react differently to the cellphone commands and data when a teenager drives the vehicle. In this application's parent applications and patents, this signal does not yet indicate when a teenager is driving the aforementioned vehicle.

The carrier, on which the '203's courtesy signal was transmitted from the courtesy signal transmitter to the cellphones' courtesy signal receivers, was described therein as a either an ultrasonic signal or a low-power radiofrequency signal. Implementing a plurality of different courtesy signals on the same carrier requires an extensive basic design effort to select the most suitable carrier, communication packet formats and protocols to carry the courtesy signals on a single carrier. This design effort is avoidable.

The parent patents and applications disclosed a system in which a courtesy signal receiver is coupled through a space between some cellphone's keyboard keys, to withstand a user's attempt to block the aforementioned courtesy signal in order to make the system inoperable. But some high-end cellphones and equivalent devices may use touch-screen technology, where there is no equivalent to the space between keys in which the cellphone's audio microphone and courtesy signal receiver can be mounted. Systems described in parent patents and applications do not yet show how a cellphone's audio microphone and courtesy signal receiver could be coupled through a touch-screen display.

This application discloses techniques to overcome inadequate aspects in this application's parent patents and applications.

### SUMMARY OF THE INVENTION

This invention introduces three mechanisms for transferring signals through the systems described in the parent applications and patents that have been incorporated by reference in this application. These are for inputting information from the driver's ignition key though the aforementioned vehicle's ignition key lock, simultaneously receiving courtesy signals from both low-power radiofrequency and ultrasonic carriers, and receiving ultrasonic courtesy signals through a touch-screen.

This application introduces the use of a signal from the driver's key through the aforementioned vehicle's ignition key lock, the use of a memory in the key lock assembly to hold the previous value of ignition key lock signals, and the reuse of the previously introduced concept of an override, to determine whether the cellphone user, who is the moving vehicle driver, will be inhibited from texting.

The discussion above suggests how texting can be inhibited. Audio output, from cellphone user to microphone to cellphone tower, can be inhibited in like manner. Both texting and the microphone can be inhibited together, if both are considered dangerous.

The second part of this invention implements the courtesy signal transmitted from a courtesy signal transmitter coupled to the aforementioned vehicle's frame to the cellphone's courtesy signal receivers on a pair of carriers, a low-power radiofrequency and an ultrasonic carrier. It can use simpler well-known techniques for each carrier by implementing each courtesy signal on a different carrier, thereby bypassing the design effort needed for putting a plurality of signals on a single carrier.

The final input mechanism disclosed in this patent application is used in courteous cellphones that use touch-screen technology and that receive courtesy signals on an ultrasonic carrier. The mechanism disables some key in the keyboard when the courtesy signal receiver is blocked. Running applications (apps) requiring the use of the aforementioned disabled key causes the apps to fail or to become unacceptably annoying to use.

This application's inventor believes this system could reduce the number of fatal accidents, caused by teenage drivers texting while the vehicle is in motion, from the thousands to a few tens per year, while not interfering with safe uses of texting or other safe apps.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the several figures of which like reference numerals identify like elements, and in which:

FIG. 1 is a graphical description of a Mealy-model sequential machine that controls the driver's inhibiting of texting in a moving vehicle.

FIG. 2 is a block diagram showing components of a courteous cellphone system according to this application's parent applications and patents, which are relevant to this application.

FIG. 3 is a block diagram showing relevant components of a courteous cellphone system according to this application.

FIG. 4 is a set of timing diagrams illustrating the ultrasonic measurements used in the GPS-like subsystem used to determine the location of the cellphone in the aforementioned vehicle.

FIG. 5 shows the front view of a digital microphone-courtesy signal receiver laminated into the touch screen.

FIG. 6 shows the side view of a digital microphone-courtesy signal receiver laminated into the touch screen.

FIG. 7 shows the front view of a wide range microphone-courtesy signal receiver disposed underneath the touch screen.

FIG. 8 shows the side view of a wide range microphone-courtesy signal receiver disposed underneath the touch screen.

### DESCRIPTION OF A PREFERRED EMBODIMENT

The first novel input subsystem disclosed in this application inputs a signal from the moving vehicle's ignition key that determines the current vehicle driver's maturity (whether the driver is a teenager or not), in order to establish whether or not aforementioned driver can override the system's inhibiting texting while driving.

The ignition key appears to be the best way to convey the driver's level of maturity. When a vehicle's driver misplaces his or her ignition key, he or she immediately looks for it, until it is found. This application's inventor hardly ever loans his car keys to his children, colleagues or friends. A vehicle's ignition key is occasionally given to a parking garage attendant to enable him or her to park and later retrieve the aforementioned vehicle, but this attendant is not likely going to want to be texting while driving. Although draconian technology is available for conveying the driver's level of maturity, such as implanting an RFID chip into each driver's right hand wrist, this implanting would be about as unacceptable as killing a fly with a sledge hammer. The vehicle's ignition key is suited to convey the driver's level of maturity as discussed below.

The following discussion uses terms like key and key lock to describe the abovementioned mechanism. The ignition key is what the driver has in his or her pocket or purse, which he or she inserts into a key lock (a socket) to start the vehicle. That vehicle's ignition key lock is where the driver inserts the aforementioned ignition key. Similarly, the key that controls the operation of the system that is described by this disclosure is the courtesy key, the socket where the courtesy key is inserted to control this aforementioned system is the courtesy key lock, the combination of the two keys, the ignition key and courtesy key, is the combined key, and the combination of the two key locks is the combined key lock.

The ignition and courtesy keys can be mechanically tightly coupled if, for example, the ignition key and courtesy key are both part of a rigid apparatus such that if one turns, the other turns by the same amount. They can be loosely coupled if, for example, they are preferably usually put on the same key chain, so that each key may move freely within a range of motion.

The ignition key and lock can be a mechanical-electrical pair of modules like the simple house key. The key code and other data can be implemented in high ridges and low indentations of the key's edge. Alternatively, the courtesy key can be a flash memory, and the courtesy key lock can be a microcontroller. The key code data can be implemented in the courtesy key's microcontroller's nonvolatile memory, as shown below.

The electronic-microcontroller key can provide more information about the driver, such as his or her birthday (used to automatically obtain the driver's maturity), the electronic vehicle identification number (yin number, used to track cars), a list of prior fines, arrests and cellphone-related accidents, and other limitations. A driver who has been in an accident involving cellphone usage, or a driver who has arrangements with an insurance company to reduce his or her insurance cost, or an adult that excessively allows a teen to override inhibiting of texting, as further discussed below, might be treated like a teenager with respect to this application.

The microcontroller subsystem in an electronic-microcontroller key can be organized in two parts. A first part is generally coupled mechanically to the key and relates to the aforementioned user information in flash memory; it could be stored in a chip like the Dallas Semiconductor/Maxim DS2431. A second part, generally coupled mechanically to the key lock and relating to courtesy signal transmitters and receivers that are mounted in the vehicle's interior. The microcontroller can be connected to the aforementioned second part. Any microcontroller should be able to implement the second part.

Each moving vehicle will have at least two different courtesy key types. A courtesy key of the first driver's key type, denoted the inhibiting key (I-type key), is inserted into the aforementioned vehicle's combined key lock to start and run the vehicle in which the vehicle driver is inhibited from texting, as described in '203. A second courtesy key type, denoted the override key type (O-type key), is inserted into the vehicle's ignition key lock to start and run the vehicle, in which the vehicle's driver is enabled to use texting while the vehicle is in motion. Only one key at a time can be inserted into the vehicle's ignition key lock. The encoding of the signal read from an I-type key through the ignition vehicle key lock will be as different as possible from the encoding of the signal read from an O-type key through the aforementioned vehicle ignition key lock, to prevent a counterfeiter from using a key of one key type to make the key of the other key type.

A parent might buy a car and give it as a present to his or her teenage son or daughter. All keys for this car should be I-type to inhibit texting in this car. An adult might buy a car for his or her own use. All keys for this car may be O-type to override inhibiting texting in this car. If a car is expected to be routinely driven both by adults and teenagers, then a mixture of key types, both I-type key and O-type key types, will be used for the car's combined key lock.

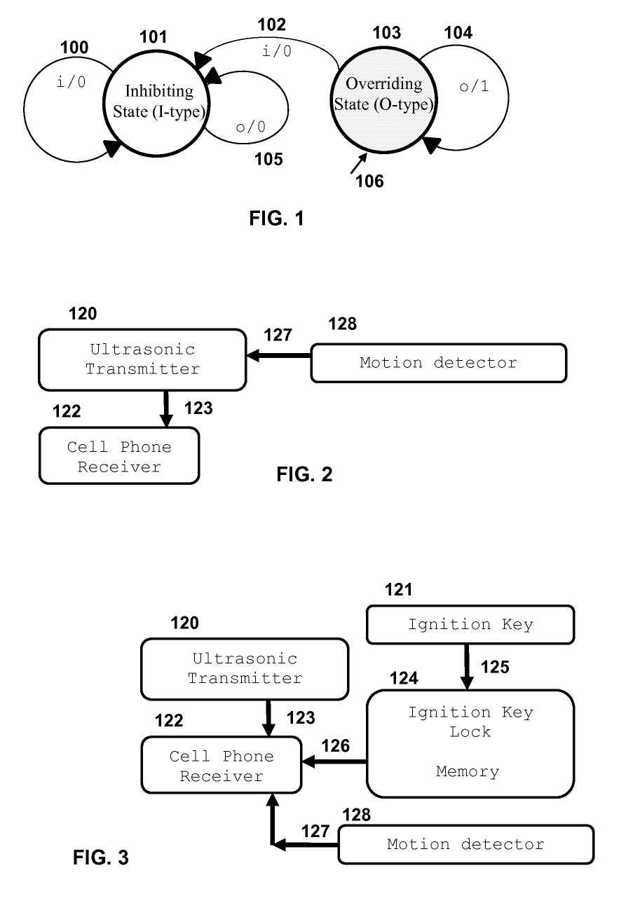

The response to inserting a courtesy key into the courtesy key lock is described by the simple 2-state sequential machine (SM) shown in FIG. 1. The SM's input states are: (i) insert an I-type key into the aforementioned vehicle's ignition key lock and (o) insert an O-type key into the vehicle's ignition key lock. The SM's internal states are: 101 (I-type) the driver's texting is inhibited while the vehicle is in motion, and 103 (O-type) the driver's texting is allowed while the vehicle is in motion. The SM's output states are: (0) the courtesy signal transmitted to the cellphone prevents the driver's texting when the vehicle is moving, and (1) the courtesy signal transmitted to the cellphone allows the driver's texting when the aforementioned vehicle is moving. The SM's initialization 106 starts the SM in the override state 103 (O-type).

The previous type of key, that was in the courtesy key lock just before a different courtesy key is inserted into it, will be stored in a memory so that a change of key type can be detected. A change from an O-type to an O-type (SM transition 104) will be carried out, resulting in continuing overriding inhibiting texting. A change from an I-type to an I-type (SM transition 100) results in further inhibiting texting. A change from an O-type to an I-type (SM transition 102) inhibits texting. A change from an I-type to an O-type (SM transition 105) is ignored, but automatically calls or texts the service operator. A cellphone user wishing to allow texting, can thus be connected to the service center that handles emergency overrides, as described below.

The SM state transitions described above can be further overridden by the cellphone service provider's service center operator. The operator can force the SM's to be in either the O-type or I-type states by sending a command, via the cellphone tower, to the cellphone. The execution of this command ignores the previous SM state and forces the SM's present state to be either O-type or I-type, as chosen by the cellphone user.

One reason for the operator forcing the SM state might be where an emergency has occurred outside the system described in this application, and the cellphone user needs to use texting to respond to the emergency. The operator causes the cellphone to record the current SM state, forces the SM state to be O-type until the emergency has passed, and then restores the previously saved SM state.

Note above that the user inserting an O-type key when the previous key had been I-type automatically results in a voice or texting call to the service provider. The cellphone, connected to the key lock in which the insertion is done, will call the service provider's operator. The operator might determine if the aforementioned cellphone user is excessively abusing the privilege of overriding. If so, the override can be declined. The operator might ask the user some questions to verify that the user, who requests overriding the inhibiting of texting, is a responsible adult and owns or co-owns the vehicle. The operator might charge a service fee. If the override is allowed, the operator can initialize the SM state machine to be the override O-type state.

A related reason, for the operator to force the SM state to I-type, results from a responsible adult authorizing forcing too many teenager's SM state to O-type. The operator may leave unmodified the teenager's state to I-type and also force the responsible adult SM state to I-type, because the supposedly responsible adult has turned out to be irresponsible.

If there are a plurality of different situations allowing different parts of the inhibiting mechanism (for instance, doing something when the service center operator overrides inhibiting that is different when an O-type key overrides inhibiting), more states can be defined for the SM to establish a driver's maturity with respect to inhibiting texting, or inhibiting other risky operations while the cellphone user is driving a moving vehicle.

When a driver's cellphone's texting is inhibited, texting is not necessarily totally inoperable. If the vehicle's driver is inhibited from texting because the vehicle is moving, the driver is still generally capable of viewing pictures displayed on the cellphone display that may have been saved, or might be set up by a passenger. The passenger can press an unlimited number of keys, as well as doing other things that the driver cannot safely do. Then the passenger can pass the cellphone to the driver for the driver to see the display.

Alternatively, if passing a cellphone back and forth between a driver and a passenger is found to be unacceptably dangerous, this action can be prevented by observing changes in the position of the cellphone in the aforementioned vehicle determined by the ultrasound-based GPS subsystem described in the '203 patent. The cellphone display can be cleared when the cellphone is passed from any passenger to the driver of the aforementioned vehicle.

As an example of the assignment of the I-type and O-type states described above, consider a family comprising of a mother, father, teenage son and teenage daughter who drive the family car. Father and mother are given O-type keys when the car was bought, the daughter being given an I-type key, and the son not being given a key for this car so far.

If mother and father are alone on a trip, they can both use the O-type key that, say the father had inserted into the key lock when the trip began. It is assumed that the mature adults will take sufficient care to avoid accidents when they use O-type keys. As the mother replaces the father when he gets tired, she leaves his O-type key in the key lock. The key type remains an O-type. Mother and father use the same O-type key and are able to text while driving, without paying any penalty or fine for switching drivers. Obviously the roles of mother and father can be reversed in this example.

If the whole family is on a trip, and the son (who does not have a key) wants to be texting while driving, the father can call the cellphone provider's service center operator to enable texting. The service center operator might caution the son, talk to the father to get an adult's permission for the son's request, and receive a fee to defray the service center operator's expenses.

If the daughter drives the car, starting from its being in the garage, her I-type key inhibits her from texting while the car is moving. If she has good reason to override inhibiting texting, she can, with their permission, pull over and stop the car, insert either mother's or father's O-type key, whichever adult is in the car, which will call the service center operator as the son did above. If mother is in the car, inserting the mother's key which is an O-type key, will automatically call the service center. Calling the service center operator, as discussed for the son, the operator can override the daughter's inhibiting of texting while she is driving.

Use of this key system might benefit from new laws. A teenager having inserted an improperly obtained O-type key in the ignition key lock, whence it was found after an accident or during a police inspection, could be liable to penalties and fines resulting from the aforementioned teenager inserting the improperly obtained O-type key into the courtesy key lock, in addition to charges and fines due to the accident, if there are some. The adult, who had authorized the teenager to have an O-type key in the ignition key lock leading up to an accident, or police inspection, could be liable to penalties and fines resulting from the accident or police inspection. The acquiring of fines or penalties described above should be enforced by new laws adjudicated in traffic courts. Absent these laws, the end-user license agreement (EULA) can be used to contract the cellphone owner to help protect the system described in this application.

Resuming the family example above, the following situations result in the indicated fines and penalties: (1) the son has a fender-bender while using an O-type key, and no responsible adult has authorized the son's use of the O-type key—the son pays penalties and fines related to the accident itself and penalties and fines related to son's use of the O-type key. (2) the daughter has a fender-bender while using an O-type key, and mother has authorized the daughter's use of the O-type key to the service center operator—the daughter pays penalties and fines related to the accident itself only and mother pays penalties and fines related to the daughter's use of the O-type key. (3) the daughter has a fender-bender while using an I-type key—the daughter pays penalties and fines related to the accident itself but no penalties and fines related to the daughter's use of the I-type key. (4) the father has a fender-bender while using an I-type key—father pays penalties and fines related to the accident itself but no penalties or fines related to father's use of the I-type key. (5) father has a fender-bender while using an O-type key—father pays penalties and fines related to the accident itself and penalties and fines related to father's use of the O-type key. (6) police officer stops and inspects the son for an expired license, who is using an O-type key, no responsible adult has vouched for the son—the son pays penalties and fines related to officer's inspection and related to son's unauthorized use of the O-type key. (7) a police officer stops and inspects the daughter to check for an illegal substance in the car, who is using an I-type key, the mother has vouched to the service operator for the daughter to text while vehicle is moving—the daughter pays no penalties and fines related to her unauthorized use of the I-type key but pays any fees or penalties that result in the officer's inspection.

Also, the output state might be displayed by LED signal lights, say on the aforementioned vehicle's dashboard, so that, when a vehicle is inspected from outside, the inspector might quickly determine the maturity level of the driver conveyed to the texting inhibiting system. If such signal lights are used, this application's inventor claims ownership of an apparatus in which the lights are rewired in any way to misinform the inspector about the driver's level of maturity that is passed out of the key lock subsystem.

Whenever this subsystem is installed in the aforementioned vehicle at the time that this vehicle is originally built, the subsystem should use a mechanically tightly coupled key and key lock, have the ignition key determine the key type and transmit the key type through an embedded inaccessible courtesy signal transmitter and signal path that are hard to remove.

Alternatively, where a vehicle owner optionally installs a system that is described in this application as an aftermarket system in the aforementioned vehicle, that vehicle's ignition key lock might be difficult to alter to indicate the key type, or to be mechanically tightly connected to the ignition key lock. A loosely coupled key can be used to behave like the tightly coupled key described above, wherein the courtesy key and the ignition key could be coupled together on a short key chain so they can be inserted together into their respective locks. This subsystem's key and key lock should be designed so that only one courtesy key can be inserted into this system's key lock at any given time, and should require that it and the ignition key are consistently used, the courtesy key being inserted just before the ignition key inserted to make the engine run.

This application's inventor claims ownership of apparatuses or methods that falsely imitate the key or key lock subsystem, or can defeat or contraindicate the courtesy key signal that is transmitted from the courtesy signal transmitter to the cellphone's courtesy signal receiver, in order to prevent this system from working correctly. The key subsystem can be falsely indicated by writing the processor's nonvolatile memory with different addresses-code words. The key lock subsystem can be falsely indicated by shorting its output to ‘1’ level to provide an indication that the inhibiting is overridden, regardless of the key addresses-code words. Each case above renders the system described herein ineffective.

This application's second mechanism introduces an alternative to previously described mechanisms that convey the courtesy signal from courtesy signal transmitters coupled to the aforementioned vehicle's frame to courtesy signal receivers embedded in courteous cellphones. FIG. 2 shows the connection of relevant courtesy signals according to this application's parent patents and applications. An ultrasonic transmitter 120 sends timing information and a packet of data through ultrasonic courtesy signal path 123 to cellphone 122. Even though only one transmitter is shown, four such courtesy signal transmitters and paths send timing information for an ultrasonic GPS-like operation that determines the position of the cellphone in the vehicle. In the '203, the same four transmitters and paths also send courtesy signal commands and data to the cellphone. One such data item sent through one of the courtesy signals is a signal 127 from motion detector 128, which indicates whether or not the aforementioned vehicle is moving.

FIG. 3 shows the relevant courtesy signals for a system according to this application. Components 120, 122, 127 and 128 operate essentially as they do in FIG. 2 except that motion detector's 128 signal 127 does not feed through ultrasonic courtesy signal 123. Rather, courtesy signal 123 is transmitted without data as an ultrasonic “ping”, and courteous cellphone commands and data are transmitted as bits in a low-power radiofrequency signal. The ultrasonic signal is discussed first, and the low-power radiofrequency signal is discussed next.

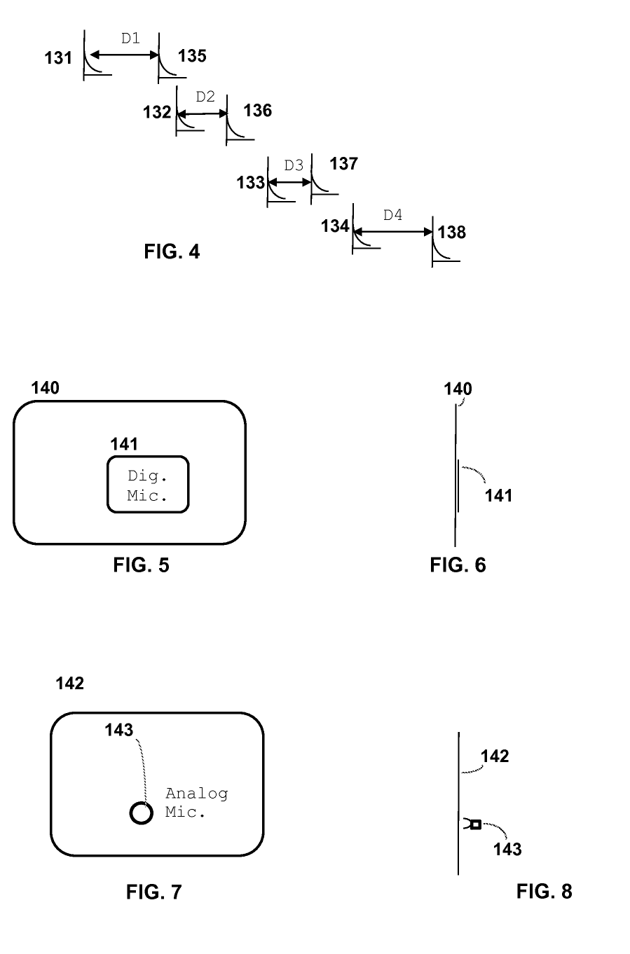

The ultrasonic signal components shown in FIG. 4 are used to determine signal delays, transmitting and receiving a “ping” essentially like the Parallax.com Ping))) device. Four ultrasonic transmitters disposed in four of the aforementioned vehicle's speakers send ultrasonic courtesy signal pulses. FIG. 4's Item 131 is a timing diagram of an ultrasonic courtesy signal waveform (an exponentially decaying voltage) obtained directly from one of the ultrasonic transmitters, item 135 is that courtesy signal as it is received by the cellphone courtesy signal receiver (which is the cellphone's microphone), and D1 is the delay of the signal from transmitter to receiver. Similarly, Item 132 is a timing diagram of an ultrasonic signal obtained from another of the ultrasonic transmitters, item 136 is that signal as it is received by the cellphone courtesy signal receiver (which is also the same microphone), and D2 is the delay of that signal from transmitter to receiver, item 133 is a timing diagram of an ultrasonic signal obtained from another of the ultrasonic transmitters, item 137 is that signal as it is received by the cellphone courtesy signal receiver (which is also the microphone), and D3 is the delay of that signal from transmitter to receiver, and item 134 is a timing diagram of an ultrasonic signal obtained from the fourth ultrasonic transmitter, item 138 is that signal as it is received by the cellphone courtesy signal receiver (which is also the microphone), and D4 is the delay of that signal from transmitter to receiver. The pulses 131, 132, 133, 134, and back to 131, are transmitted spaced out, each pulse beginning precisely the same time after the previous pulse was begun, all such intervals being longer than the longest possible delays D1, D2, D3 or D4. Pulses are repetitively transmitted in a continuous loop. The first aforementioned pulse described by waveform 131, is transmitted again after the last pulse described by waveform 134.

The methodology described above could be disrupted by a cellphone user, which would make this system inoperable. To make it more difficult to disrupt the timing, a random number N is read from a single free-running counter. This random number N is added to each aforementioned delay by each ultrasonic transmitter, transmitted over a low-power radiofrequency carrier, and subtracted from the incoming delay by the ultrasonic receiver in each cellphone. These resulting delays, D1, D2, D3 and D4, should not be so long so as to compute that the cellphone is outside the vehicle. These delays, D1, D2, D3 and D4, should not change at a fast rate since they represent the location of the cellphone with respect to the vehicle, which cannot change fast due to its momentum. Adding N to the aforementioned delays before the transmitter's input transmits D1+N, D2+N and D3+N and D4+N, then subtracting N after the receiver outputs D1+N, D2+N and D3+N and D4+N, gives D1, D2, D3 and D4. If some last computed values change at a fast rate, or the cellphone's position is computed to be outside the vehicle, the positioning courtesy signals are compromised, then the cellphone microcontroller should make the key lock state the I-type (inhibit) state. Recall that making the SM state the I state inhibits texting.

As discussed above, ultrasonic courtesy signals are very well suited to measure GPS-like positioning signal. However, the motion detector courtesy signal can be transmitted using ultrasonic paths, or it can be transmitted using low-power radiofrequency paths.

This application observes the advantage of using only ultrasonic for positioning, and using low-power radiofrequency for all others. The low-power radiofrequency courtesy signal will be made to synchronize the ultrasonic courtesy signal transmitters located proximate to or part of the aforementioned vehicle's speakers. This radiofrequency courtesy signal is repetitively cyclically transmitted with a period that is at least four times longer than the ultrasonic signal's longest pulse width. Each ultrasonic transmitter disposed in a vehicle's speaker receives the low-power radiofrequency courtesy signal, delays the starting time of the aforementioned low-power radiofrequency courtesy signal by a different amount of time, and transmits the ultrasonic exponential waveform from the ultrasonic transmitter.

The aforementioned random number N is transmitted in a field on the low-power radiofrequency signal and then added to each ultrasonic courtesy signal transmitter and the ultrasonic courtesy signal receiver embedded in each cellphone's microphone to prevent the aforementioned ultrasonic “ping” from being counterfeited. The value of N sent on the low-power radiofrequency signal delay can be encrypted. A minimal encryption could be appending a parity bit to each value that is transmitted, which would confuse some individuals who have no understanding of communication systems, but actually a more powerful encryption should be used to protect the value of N.

The courtesy signal commands and data are transmitted from the ignition key 121 through courtesy signal path 125 to the ignition key lock 124 and through courtesy signal 126 to the cellphone 122, and from motion detector 128 through courtesy signal 127 to the same cellphone 122. The combined signals can be transmitted on different bits of a frame of commands and data of a serial low power radiofrequency courtesy signal transmitted to the cellphone. The frame can be transmitted over a low-power radiofrequency transmitter/receiver system such as the Freescale ZigBee system. These courtesy signals are simplex; information flows in one direction only.

The final mechanism disclosed in this application shows how a cellphone with touch-screen display can receive the courtesy signal in a manner which is difficult to block. The low-power radiofrequency courtesy signal can be blocked by enclosing the cellphone in a Faraday cage, as discussed in the '203 patent. The ultrasonic receiver can be blocked by jamming the courtesy signal with a higher power signal. Such jamming is easily detectable and should result in inhibiting all subsequent texting. The ultrasonic courtesy signal can be blocked by covering the ultrasonic transmitter or the ultrasonic receiver, such as with a wad of gum, or by providing an earlier exponential decaying signal than the exponential decaying courtesy signals indicated by timing diagrams 135, 136, 137, or 138. Such blocking is detectable and should result in inhibit subsequent texting, as discussed below.

The further ultrasonic signal reception methodology comprises two concepts: the integration of the ultrasonic courtesy signal receiver, which is also the cellphone's microphone, into the touch-screen display, and the location of the receiver-microphone in the touch-screen display.

The ultrasonic courtesy receiver-microphone can be coupled to the touch-screen in at least two ways. As illustrated in FIG. 5, which is a front view, and FIG. 6, which is a side view, a MEMS digital microphone 141 such as the AD ADMP421 can be laminated into the touch-screen 140 to receive both courtesy and audio signals. If the touch-screen is transparent to audio and ultrasonic signals, as shown in FIG. 7 (front view) and FIG. 8 (side view), a wide bandwidth audio microphone, 143, like the Knowles Electronics EK-3132, can be positioned underneath the touch-screen 142 to receive both courtesy and audio signals.

To avoid having an ultrasonic receiver with microphone under each potentially useful keyboard key position, only a small number of often-used keys should have a microphone-courtesy signal receiver laminated with them, or have a microphone-courtesy signal receiver below them.

For texting, the touch-screen display, serving as a QWERTY keyboard, could use the space key as the one and only key in which a microphone-courtesy signal receiver is located. If the cellphone user blocks the microphone-courtesy signal receiver, say with a wad of gum, the text transmitted from the cellphone radiofrequency transmitter to the service provider's tower would contain no spaces, appearing crunched to the text recipient and any receiver monitoring the text. To further deter blocking, where the cellphone microcontroller detects that a lot of text is being generated without spaces, the cellphone service provider could be notified by the cellphone of this situation.

As a second example, in a GPS map application, the left-arrow (or right-arrow or up-arrow or down-arrow) could be the one and only key in which a microphone-courtesy signal receiver is located. Disabling that key, say with a wad of gum, could result in the map program having no convenient way to move leftward (or rightward or upward or downward). A cellphone with many applications, a small number of such keys that also operate as microphone-ultrasonic courtesy signal receiver, could be made available to each application to operate as microphone-ultrasonic courtesy signal receiver. However, the location of these keys should be unaffected when other panes on the screen are zoomed in or out, rotated, transposed, or otherwise repositioned.

When both ultrasonic and low-power radiofrequency courtesy signals are used, in which both courtesy signal receivers should each be either both be operable or both be inoperable, the problem of detecting that the system is being interfered with is helped by finding out when only one signal is being interfered with, and the other signal operates normally. In a system using low-power radiofrequency along with ultrasonic courtesy signals, slipping a Faraday cage over the cellphone to block radiofrequency courtesy signals while the ultrasonic signals appear valid, can be detected, and this diagnostic information can be sent to the cellphone provider, or stored in a log memory in the cellphone. Eventually, when one path works and the other does not, the cellphone's control system can observe that the cellphone courtesy signal receiver may be compromised, so all texting will be inhibited.

The system described in this application may be extended to solve different problems. Parent patents and applications showed how similar systems can inhibit cellphone ringers from ringing, radiofrequency transmitters from transmitting, black out still and video cameras can be from taking pictures, and so on. As a growing number of electronic games or personal assistance devices flood our living space, those devices with a need to inhibit some operations, usually when the users drive a moving vehicle, can use systems described in this application to avoid risky operations in them by drivers of moving vehicles.

This application can be modified to be downloaded with different parameters (e.g. the number of keystrokes allowed before the keyboard is disabled could be changed to 5). Generally, although this application described most operations in terms of their hardware implementation, most operations should be implemented in software procedures. The cellphone provider should be required to be able to be able to download data into all cellphone processor memories to modify the abovementioned data parameters and procedures. The cellphone provider should permit these data parameters and procedures to be individually set in compliance with local, state, and national laws and guidelines.

Modifications to this invention can be made by one skilled in the art without departing from the spirit of the invention. While the invention has been described in connection with illustrative embodiments, obvious variations therein will be apparent to those skilled in the art without the exercise of invention, accordingly the invention should be limited only to the scope of the appended claims.

I claim:

1. A system for inhibiting teenage moving vehicle's drivers from engaging in cellphone texting and similar dangerous activities while said moving vehicle is in motion, comprising:
(a) a motion detector, able to indicate through a courtesy signal that said vehicle is in motion,
(b) an ignition key and key lock subsystem disposed to allow said vehicle driver to start and run said vehicle.
(c) a courtesy key and key lock system, coupled to said ignition key and key lock subsystem, able to transmit a courtesy signal indicating whether said vehicle's driver is able to engage in texting (override signal), or said vehicle's driver's cellphone will inhibit texting whenever said vehicle is in motion (inhibit signal),
(d) a contiguous interior compartment of said vehicle wherein passengers may be located, said contiguous interior compartment comprising:
(i) at least four positioning courtesy signal transmitters,
(ii) at least one cellphone operated by a cellphone user,
(iii) a vehicle control apparatus comprising a steering wheel, brakes and accelerator pedal, which controls the moving vehicle's speed and direction,
(iv) a vehicle driver, positioned to operate said vehicle control apparatus, who may also be said cellphone user, and
(e) each said cellphone comprising:
(i) a radio frequency voice and data carrier signal transceiver capable of carrying at least text messages between said cellphone in said moving vehicle and another cellphone, and capable of receiving a command, over said radio frequency voice and data carrier signal, to inhibit texting or override said inhibiting,
(ii) a display enabling the user to read at least received text messages,
(iii) a keyboard capable of entering text, typed in by said cellphone user,
(iv) a microphone to receive audio signals spoken by said cellphone user, and
(v) a processor capable of controlling said cellphone, of receiving said four positioning courtesy signals, determining cellphone position relative to the vehicle, using GPS-like calculations operating on said four positioning courtesy signals, and determining whether said position is within reach of said vehicle driver,
wherein said vehicle's driver's texting is inhibited when said cellphone user inserts said I-type key into said key lock, said vehicle is moving and said cellphone is within reach of said vehicle driver, but said inhibiting is overridden if the cellphone user inserts said O-type key into said key lock (unless the previous key type was I-type), or an override command is received from the cellphone service advisor to override inhibiting texting, unless an inhibit command is received from the cellphone service advisor to inhibit texting.

2. A system as defined in claim 1 wherein said motion detection is based on the speed obtained from said vehicle's speedometer.

3. A system as defined in claim 1 wherein said motion detection is based on the signal output from an accelerometer disposed in said vehicle.

4. A system as defined in claim 1 wherein said courtesy key is mechanically tightly coupled to said vehicle's ignition key such that rotating or pushing the coupled keys in their key locks affects vehicle and system operation together, and wherein said courtesy key is inserted into said courtesy key lock to inhibit or override the inhibiting of texting.

5. A system as defined in claim 1 wherein said courtesy key is mechanically loosely coupled to said vehicle's key, and wherein said courtesy key lock is not mechanically tightly coupled to said vehicle ignition key lock but is positioned in said vehicle, wherein said courtesy key is inserted into said courtesy key lock to inhibit, or override the inhibiting of, texting.

6. A system as defined in claim 1 wherein said vehicle ignition key and said courtesy key are electrical-mechanical switches wherein rotation, or pushing, of the key affects courtesy signals.

7. A system as defined in claim 1 wherein said vehicle ignition key and said courtesy key are electronically coupled to a microcontroller disposed within said key wherein rotation or pushing of the key affects microcontroller I-type/O-type port signals.

8. A system as defined in claim 1 wherein a key-lock subsystem of claim 1's system has lights indicating the key-lock subsystem's output, said lights being rewired to falsely display said subsystems' output state, in order to misinform an inspector who is inspecting said system.

9. A system as defined in claim 1 wherein said motion detector of claim 1's system fails to correctly report that the vehicle is moving, in order to prevent said system from working correctly as defined by claim 1.

10. A system as defined in claim 1 wherein said key subsystem of claim 1's system is replaced by a subsystem that falsely implements said system's key subsystem, returning an override value 1 when it should return an inhibit value 0, in order to prevent said system from working correctly as defined by claim 1.

11. A system as defined in claim 1 wherein said key-lock subsystem of claim 1's system returns data or key codes that will provide incorrect information to said key subsystem, in order to prevent said system from working correctly as defined by claim 1.

12. A system as defined in claim 1 wherein the courtesy signal carrying the motion indicator signal, and carrying courteous key information, uses an ultrasonic carrier.

13. A system as defined in claim 1 wherein the courtesy signal carrying the motion indicator signal, and carrying courtesy key information, uses a low-power radiofrequency carrier.

14. An apparatus comprising an LCD display and a courtesy signal receiver, said LCD display displaying visual information, and said receiver receiving a signal at a predetermined fixed location of said display comprising:
(a) an LCD display, displaying a window composed of panes, said panes generally capable of being is zoomed in or out, rotated, transposed, or otherwise repositioned,
(b) a courtesy signal receiver, disposed at a predetermined pane of the window, said pane remaining immovable on said display even when the other panes of the display are repositioned,
(c) a process normally executed in said cellphone's microcontroller when said cellphone user touches the touch-screen in said predetermined immovable pane, said process being commonly and importantly used by the application.
wherein blocking said courtesy signal at its receiver renders said process inoperable, or difficult to use, whence said cellphone user's touches the touch-screen in said immovable pane fails to execute said predetermined pane's process.

16. A system as defined in claim 14 wherein said courtesy signal is an audible signal and is received by a microphone.

17. A system as defined in claim 14 wherein said courtesy signal is an ultrasonic signal and is received by an ultrasonic receiver.

18. A system as defined in claim 14 where said courtesy signal receiver is laminated into said touch-screen.

19. A system as defined in claim 14 where said courtesy signal receiver is located under said touch-screen.

20. A method for inhibiting teenage moving vehicle's drivers from engaging in cellphone texting and similar dangerous activities while said moving vehicle is in motion, comprising the steps of:
(a) detecting motion by a motion detector in the vehicle, transmitting said detection courtesy signal to be received by a courtesy signal receiver within each said cellphone,
(b) detecting the driver's maturity using a courtesy key and key lock subsystem tightly coupled to said vehicle's ignition key and key lock subsystem, disposed to allow said vehicle operator to start and run said vehicle, transmitting said detection courtesy signal, receiving said signal by a courtesy signal receiver within each said cellphone,
(c) detecting the cellphone location in said vehicle using at least four ultrasonic positioning courtesy signals from four courtesy signal transmitters disposed in a predetermined position within said vehicle, each transmitting a pulse at different times, each said positioning courtesy signal being received by a courtesy signal receiver in each cellphone, and
(d) determining the cellphone's position in the vehicle from said ultrasonic courtesy signals using GPS-like calculations, and determining if said cellphone is near said vehicle driver,
wherein said driver's texting said cellphone's keyboard while said vehicle is moving may be inhibited if said cellphone's location is within reach of said driver of said vehicle, said motion indicator determines that said vehicle is moving, and said courtesy key signal is in the inhibit state, or may be inhibited by a command received from the cellphone service provider, which may be overridden by said courtesy key being in the override state, or may be overridden by said command received from the cellphone service provider being an override command.
